(19) United States
(12) Patent Application Publication
(10) Pub. No.: US 2015/0279170 A1
(43) Pub. Date: Oct. 1, 2015

(54) Systems and methods for visualizing data from a large scale multi-sensor network

(71) Applicant: HEWLETT-PACKARD DEVELOPMENT COMPANY, L.P., Houston,, TX (US)

(72) Inventors: Manish Gupta, Palo Alto, CA (US); Ravigopal Vennelakanti, Palo Alto, CA (US); Sumit Kala, Sunnyvale, CA (US); Rejith Nambiar, Pontiac, MI (US)

(73) Assignee: Hewlett-Packard Development Company, L.P., Houston, TX (US)

(21) Appl. No.: 14/439,297

(22) PCT Filed: Oct. 29, 2012
(86) PCT No.: PCT/IB2012/003070

§ 371 Date: Apr. 29, 2015

(51) Int. Cl. G08B 5/36

(52) U.S. Cl. CPC G08B 5/36

(57) ABSTRACT

Displaying status information of extraction devices includes monitoring conditions of extraction devices arranged in a physical layout and sensors contained within the extraction devices and displaying status information about the conditions for each of the sensors, where the status information is arranged in a monitor with dedicated display units that have a one to one correspondence with the physical layout such that the status information is displayed according to the physical layout of the extraction devices.

### BACKGROUND

Some networks contain hundreds of sensors. Each sensor may measure a physical parameter that is helpful for administrators or users. To accommodate the vast amounts of information, some networks aggregate the information measured with the sensors to make the measured data easier to understand.

### BRIEF DESCRIPTION OF THE DRAWINGS

The accompanying drawings illustrate various examples of the principles described herein and are a part of the specification. The illustrated examples are merely examples and do not limit the scope of the claims.

FIG. 1a is a diagram of an example of a physical layout of sensors according to principles described herein.

FIG. 1b is a diagram of an example of extraction devices according to principles described herein.

FIG. 2 is a diagram of an example of a monitor according to principles described herein.

FIG. 3 is a diagram of an example of display units according to principles described herein.

FIG. 4 is a diagram of an example of display units according to principles described herein.

FIG. 5 is a diagram of an example of a monitor for displaying status information according to principles described herein.

FIG. 6 is a diagram of an example of a method for displaying status information from sensors according to principles described herein.

FIG. 7 is a diagram of an example of a displaying system according to principles described herein.

FIG. 8 is a diagram of an example of a flowchart of a process for displaying status information according to principles described herein.

### DETAILED DESCRIPTION

Acquiring geophysical data about subterranean structures often involves spacing multiple sensors apart from each other around the subterranean structure of interest. Each sensor records information pertaining to the structure within the sensors' individual ranges. In four-dimensional seismic recording operations, the sensors record acoustic information over a period of time, usually over a couple of days. Often the sensors are collected and the recorded data is extracted. Each of the sensor's recorded data contributes to an overall understanding of the subterranean structure's characteristics.

Generally, when more sensors are involved in measuring a subterranean structure, the resulting understanding of the subterranean structure is more accurate and complete. In four-dimensional seismic surveys, thousands of sensors may be used to determine the characteristics of the subterranean structures involved in the formation of planet Earth.

The extraction devices used to retrieve the data recorded from the sensors may include thousands of individual extraction devices. The number of extraction devices deployed is dependent on the number of sensors, daily workload, and number of shifts that can be run in a day. Monitoring the status of each of the extraction devices may be complex due to the large volume of devices involved. To save resources, the technicians involved with the extraction process strive to download the recorded data in a minimal amount of time. Thus, the technicians strive to keep the extraction devices working properly during the extraction process. Due to the large number of sensors, tracking each extraction device's status is challenging.

The principles described herein include displaying status information of sensors and extraction devices. Such a method may include monitoring conditions of extraction devices arranged in a physical layout and displaying status information about the conditions for each of the sensors, where the status information is arranged in a monitor with dedicated display units that have a one to one correspondence with the physical layout such that the status information is displayed according to the physical layout of the extraction devices. The status information may contain information about the condition measured with the sensors, about condition of the sensors themselves, or of the extraction devices. The status information may be continuously updated on the monitor as operations involving the sensors progress. In some examples, the status information includes the condition of an extraction device or its corresponding sensor during an extraction process. By monitoring and displaying the status information, a user obtains a global feel visually for the condition of the components performing the operation. In some examples, the operation is data extraction, equipment monitoring, or other operations, or combinations thereof.

In the following description, for purposes of explanation, numerous specific details are set forth in order to provide a thorough understanding of the present systems and methods. It will be apparent, however, to one skilled in the art that the present apparatus, systems, and methods may be practiced without these specific details. Reference in the specification to “an example” or similar language means that a particular feature, structure, or characteristic described is included in at least that one example, but not necessarily in other examples.

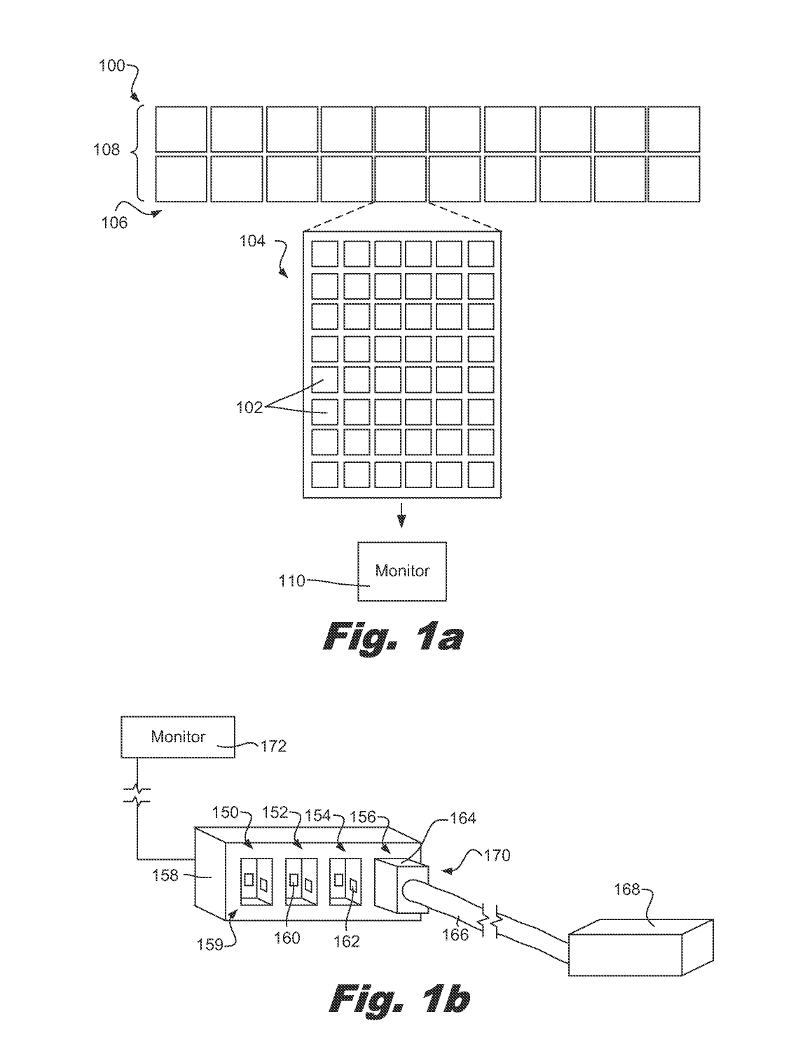

FIG. 1a is a diagram of an example of a physical layout (100) of extraction devices (102) according to principles described herein. In the illustrated example, the extraction devices (102) contain or are connected to sensors. The sensors may be sensors used in a network, in a geophysical survey, to monitor equipment, to monitor conditions of a building, to monitor hospital beds, to monitor climate control, to monitor satellites, in other applications, or combinations thereof.

The extraction devices may have a sensor built into or inserted into a cable receptacle. In other examples, the data extraction devices may form a connection with sensors. The receptacles are arranged to receive an end of a cable or other electrically conductive medium capable of transferring data and/or power. The data may be downloaded from a sensor electrically connected to the extraction device. The data may be transferred through an electrical contact or through a wireless connection located within the receptacle. In some examples, a separate electrical contact makes a physical connection with the electrically conductive medium and allows electrical power to pass through the electrical contact to charge the sensor. Alternatively, the extraction device is a wireless transceiver or apparatus capable of receiving data without a receptacle. In some examples, the data extraction devices do not have the ability to charge the sensors. A non-exhaustive list of extraction devices (102) may include Ethernet ports, cable ports, wireless devices, short wave receivers, internet protocol addressed ports, dock pockets, other extraction devices, or combinations thereof.

In the example of FIG. 1a, the sensors (102) are grouped together into a dock (104). In such an example, multiple sensors may upload recorded data simultaneously. Further, the physical layout (100) includes the docks being arranged in rows (106) such as in a trailer (108). Here, the physical layout (100) has multiple trailers (108). In some examples, a physical layout (100) of extraction devices (102) for a seismic survey has five trailers with two rows of ten docks each.

In some examples, each of the docks (104) has eight rows and six columns of extraction devices totaling 48 extractions devices per dock. In this example, the system uses a total 4,800 extraction devices. However, any number of sensors, extraction devices, docks in any arrangement may be used according to the principles described herein.

In some examples, the time needed to download the recorded data from each sensor varies from less than a minute to multiple hours. Thus, to reduce the extraction process time, multiple sensors may be connected to the extraction devices at the same time and download their recorded data simultaneously.

A user may initially connect at least some of the sensors of a survey to the extraction devices (102). In some situations, the extraction system may have enough bandwidth to extract all of the data from each of the sensors at once. However, in many situations, the system may be able to extract data from just some of the sensors at the same time. Thus, the system may include an extraction scheduler that coordinates when the recorded data from each of the sensors is extracted. In some examples, the system begins downloading recorded data from some of the sensors while a user continues to connect other sensors to the extraction devices. As a result, the total extraction process time is reduced because the system may use the time that a user is installing the sensors to download recorded data from those sensors that have already been installed.

In some examples, the recorded data is seismic data from a four-dimensional seismic survey that contains information that was recorded over a period of time. In such an example, a sensor may have been placed or laid against an earthen surface adjacent to a subterranean formation of interest. In some examples, the sensors are placed in an open borehole and pushed firmly against the borehole. In other examples, the sensors are placed on top dry ground. Yet, in other examples, the sensors are placed on the floor of a body of water that is over the subterranean structure of interest. Further, the sensors may be towed in lines behind a boat or other water vessel. The seismic survey may be from a three-dimensional seismic survey that records acoustic information from a formation, but that records data for a shorter amount of time. The acoustic information that is recorded results from an acoustic source that is purposefully denoted near the subterranean structure of interest. The acoustic waves travel through the subterranean structure and are recorded with the sensors. The characteristics of the subterranean structure affect the time and angle that acoustic signals arrive at the sensors. This data is recorded with the sensors and downloaded with the extraction device for analysis by experts to determine the subterranean structure's characteristics.

In other examples, other forms of data are recorded with the sensors. For example, electrical data, density data, buoyancy data, thermal data, pressure data, radioactivity data, chemical data, magnetic data, other forms of data, or combinations thereof may be recorded. The data may be used to determine a subterranean formation's potential for oil, gas, geothermal, mineral, other payload potential, or combinations thereof.

A user can monitor the status information of each of the extraction devices (102) or sensors. For example, the user may desire to know whether the extraction device (102) has finished extracting data, whether the extraction device (102) has not yet begun extracting data, whether the extraction device (102) is currently extracting data, and how much data the extraction device (102) has already extracted. Further, the user may desire to know whether the sensor's battery is fully charged, partially charge, or not charged at all. Also, the user may desire to know whether the extraction device (102) has a reliable connection with the sensor, whether the extraction device (102) is working, whether the sensor is responding, other status information, or combinations thereof.

In the example of FIG. 1a, the physical layout (100) is in communication with a monitor (110). The monitor (110) contains a single, one window view of the full state of the extraction system. For example, at any given point in time, a user can understand the current (or near real time) state of the extraction system by looking at the window view. The monitor (110) may be hardwired to the physical layout (100) or be in wireless communication with the physical layout (100). In this example, the monitor (100) is set up to display at least one type of status information about the extraction devices (102). In some examples, the monitor (110) is set up to display additional information about the extraction devices and/or information about the data that is being extracted. Further, the monitor may display information about the sensors in the extraction devices.

In some examples, the monitor (110) also displays alerts on a screen of the monitor (110) to notify the user about various kinds of information. For example, the monitor (110) displays an alert to notify the user if an extraction device is not working, if a sensor is not responding, if portions of the physical layout are overheating, if a sensor's battery is failing to recharge, other status information, or combinations thereof.

In some examples, the alerts are displayed next to the display units displayed in the monitor (110). The alerts are displayed in a manner that draws in a user's attention, such as with an easily noticeable color, flashing words or graphics, blinking words or graphics, other mechanisms, or combinations thereof. In some examples, the system emails or texts the alert to the user. The alerts may be time stamped and may indicate to which corresponding extraction devices or sensors the alert is concerned.

The monitor (110) has a screen with multiple pixels arranged to display any kind of graphic. Alternatively, the monitor has lights, levers, mechanical meters, other mechanisms, or combinations thereof.

FIG. 1b is a diagram of an example of extraction devices (150, 152, 154, 156) according to principles described herein. In this example, a dock (158) contains the extraction devices (150, 152, 154, 156). Each extraction device (150, 152, 154, 156) has a receptacle (159) with a wireless data transmitting device (160) and an electrical contact (162) for charging power to a sensor's batteries. An end (164) of an electrically conductive medium (166) is inserted into the receptacle of extraction device (156). In this example, the electrically conductive medium is in communication with the sensor (168) forming a physical connection (170) between the sensor (168) and extraction device (156).

When the end (164) is inserted into the extraction device's receptacle (159), the end may make a physical electrical connection with the electrical contact (162). The electrical contact may be capable of transmitting electrical power to charge the sensor's battery. The wireless device (160) may be in wireless communication with the electrically conductive medium to extract data from the sensor (168). In some examples, the data extraction and charging tasks occur simultaneously.

The wireless data transmitting device (160) may be a circuit board with an integrated circuit. The circuit may be capable of wireless data exchange. In some examples, the circuit board has a microprocessor that sends and/or receives messages with other components of the system, such as servers that are involved in the extraction process.

The extraction devices (150, 152, 154, 156) are in communication with a monitor (172) that depicts each of the sensors with a display unit in a one to one correspondence. The connection with a monitor may be direct or indirect. For example, the connection may be through one or more intermediate servers which collect information from multiple extraction devices and create a view in the monitor. The extraction devices (150, 152, 154, 156) may have a hardwired connection with the monitor or be in wireless communication.

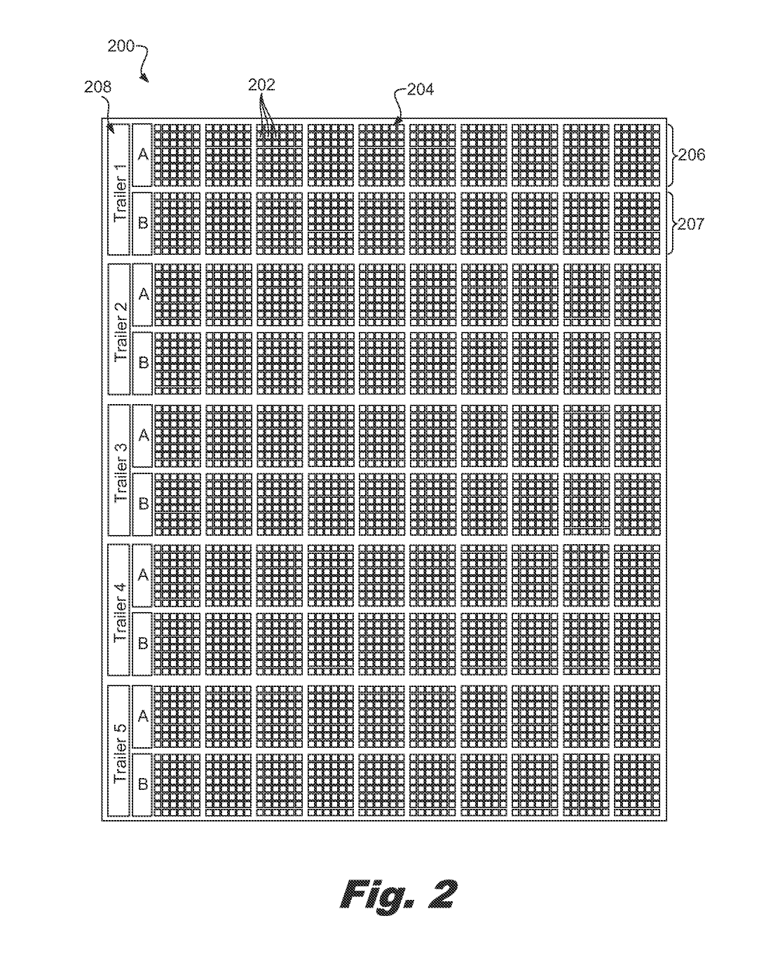

FIG. 2 is a diagram of an example of a monitor (200) according to principles described herein. In this example, the monitor (200) has multiple display units (202) that are arranged after the physical layout. In this example, the display units (202) are grouped into docks (204), rows (206, 207), and trailers (208) as the extraction devices and the sensors are in the example of FIG. 1a.

In the example of FIG. 2, the display units (202) organized into multiple trailers (208). Each trailer (208) has a row A (206) and a row B (207). Each row (206, 207) has ten docks (204). Each of the docks (204) has multiple display units (202) arranged in eight rows and six columns. Each display unit (202) may be arranged to have a one to one correspondence with the extraction devices and the sensors contained therein.

In some examples, the monitor (200) has a size sufficient to display a display unit (202) for each of the sensors. In this manner, a user visually sees information for each of the sensors. Thus, a user gets a global feel for how the extraction process is going from just looking at the monitor (200).

Each display unit (202) visually shows at least one type of information about the status of the sensors which it schematically represents. For example, each display unit (202) that schematically represents a sensor that has not begun downloading the recorded information may be a first color, each display unit that schematically represents a sensor that is in the process of downloading the recorded data may be a second color, and the display units that schematically represent sensors that have finished extracting the recorded data may be a third color. Such a system allows a user to determine quickly the global status of the extraction process or the current measurements of the sensors.

For example, a user may readily determine that a component of a dock is improperly working if the status information indicates that all of the extraction devices of that dock are not correctly working. For example, a broken switch or a cable may be severed that joins the dock to the appropriate dock row.

The monitor (200) is able to dynamically scale the number of display units (202) to reflect the actual state of the extraction devices and the sensors contained within them. For example, the system can be easily and dynamically scaled from a few to a few thousand sensors and extraction devices. Similarly, the status information being displayed in the monitor (200) can be dynamically added and/or changed as the extraction devices and/or sensors are added and removed from the system. Further, the status information may be switched to different display units as the sensors are switched to different extraction devices. This allows the user to visualize the quantities that are of most interest.

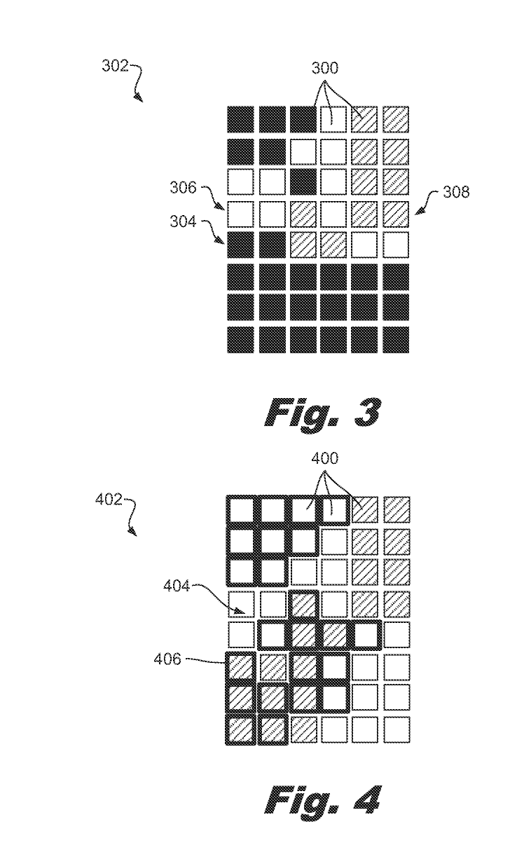

FIG. 3 is a diagram of an example of display units (300) according to principles described herein. In this example, display units (300) schematically representing extraction devices and the sensors contained therein in a dock (302) have different colors. Each color schematically represents different types of status information about the corresponding sensor. A first color (304), a second color (306), a third color (308), another color, or combinations thereof represent any type of status information about the corresponding sensors.

In alternative examples, a symbol, a hatch patter, combination of colors, other indicators, or combinations thereof may be used to represent different types of status information about the corresponding sensor. For example, a circle or other shape may appear in the display unit to represent a type of status information.

The status information may be any information that reveals a condition of the corresponding sensors. A non-exhaustive list of types of status information involving an extraction process may include charging information, extraction information, extraction speed information, percentage of completion information, temperature information, heath information, quality of connection information, whether the sensor is ready for data extraction, whether the sensor is reinserted, whether the sensor is detected, whether the sensor is responding, whether the extraction device has an error, whether the extraction device's receptacle is empty, whether the extraction device is unreachable, whether the extraction device is experiencing a temporary outage, other status information, or combinations thereof.

While the example in FIG. 3 is described with reference to three colors, any number of colors may be used according to the principles described herein. Further, while the example of FIG. 3 has been described with reference to specific symbols, shapes, colors, and patterns, any kind of indicia may be used to represent status information according to the principles described here. In some examples, the differences between different colors and/or indicia may be visually apparent to a user at a quick glance, while in other examples the difference is not quickly discernible.

In some examples, the color cell is primarily for a specific type of status information, but in predetermined situations other types of information may take priority and be displayed in the color cell. The color cell may be used primarily for charging status information. In such an example, a light blue color may indicate that the corresponding sensor is low on battery power while a darker blue color may indicate that the sensor is fully charged. However, a green color may indicate that the extraction device is not in communication with any sensor. Further, a red color may indicate that the extraction device is experiencing an error. The system may have a policy that indicates the error condition takes priority and is displayed whenever the extraction device is experiencing an error. The policy may also include that the lack of communication is a second priority, and that the corresponding display unit will display green whenever the extraction device in not in communication. The policy may specify that as a default the charging colors are to be displayed unless a condition of higher priority is present.

The colors of the color cell may gradually change from one color to another along a continuum. In this manner, the user sees a higher level of status information per display unit. For example, the continuum indicates a fully charged sensor battery when the color cell is green, while the color cell is red when the battery has a zero percent charge. The continuum may include a yellow or another color as well. As an extraction device charges the sensor, the color displayed in the color cell gradually adds incremental amounts of yellow while subtracting red. As the extraction device continues to charge, all of the red is replaced with yellow. As the charging continues further to process, the green is added to the yellow as the yellow gradually disappears until the display unit is fully charged and the color cell contains just green. However, in other examples, the color cell switches between single colors that are displayed as the charging percentage reaches predefined thresholds.

FIG. 4 is a diagram of an example of display units (400) according to principles described herein. In this example, display units (400) schematically representing extraction devices of a dock (402) in a monitor have color cells (404) with different colors and borders (406) with different colors. In this example, the cell color (404) schematically represents a first type of status information and the border color schematically represents a second type of status information. For example, the color of the cell (404) represents the charging status of the corresponding sensor while the color of the border (406) represents extraction status information about the corresponding sensor.

The second type of status information is schematically represented with a line thickness of the border. In other examples, a second type of status information is represented with the border color. Further, the borders may have line patterns, such as a dashed line pattern, to represent other status information. Alternatively, the color cell (404) or the border (406) moves, blinks, changes color, changes thickness, changes its color intensity, or otherwise changes with another mechanism, or combinations thereof to represent status information. In some examples, the existence of a border (406) verses the non-existence of a border in a display unit (400) may also represent a type of status information.

While the example of FIG. 4 has been depicted with reference to a border and a color cell to represent at least two types of status information, any indicia may be used to represent different types of status information. For example, a shape, such as a circle, within the display unit may have a color that represents a first type of status information and a background color of the display unit may represent a second type of status information. Each display unit (400) may have quadrants capable of representing different types of status information with different types of colors, borders, symbols, other types of indicia, or combinations thereof.

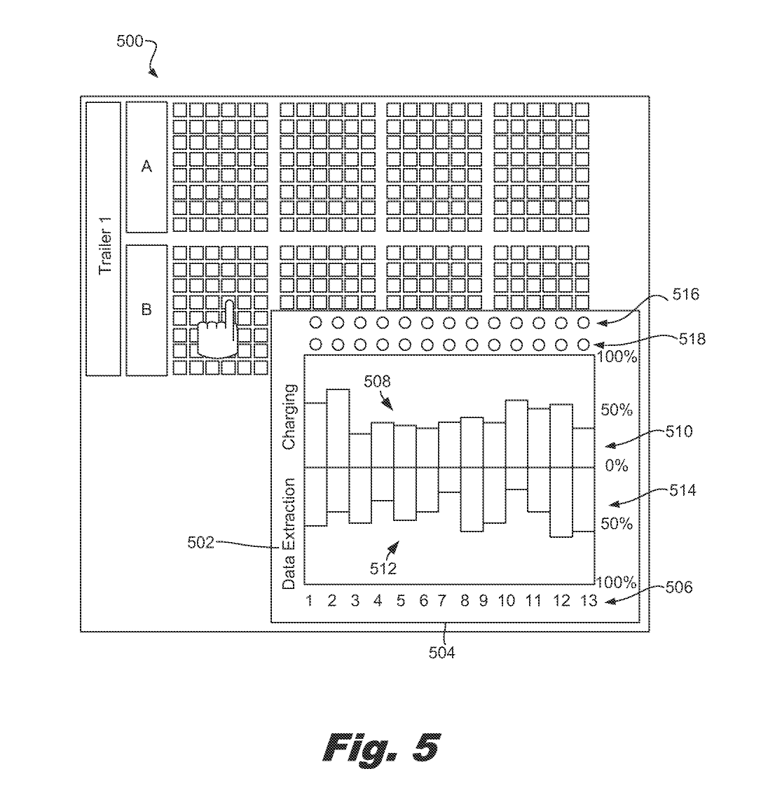

FIG. 5 is a diagram of an example of a monitor (500) for displaying status information according to principles described herein. In this example, a detailed view (502) of status information is visible. In the example of FIG. 5, the detailed view shows status information for multiple sensors. In the example of FIG. 5, the detailed view (502) contains status information for thirteen extraction devices. In some examples, all of the status information for all of the sensors in a particular dock may be visible in the detailed view (502).

In the example of FIG. 5, the x-axis (504) of the detailed view (502) schematically represents different sensors depicted with numerals (506), such as one through thirteen. The detailed view (502) includes a first bar graph (508) in an upper portion (510) that schematically represents a percentage that each of the sensors is charged. A second bar graph (512) in a lower portion (514) of the detailed view schematically represents a percentage of data extracted from the sensor.

In the illustrated example, visual depicted lights schematically represent another type of status information. In some examples, a first visually depicted light (516) and a second visually depicted light (518) schematically represent information for each of the sensors. In some examples, the different types of status information are depicted with the first visually depicted light (516) being on, with the second visually depicted light (518) being on, with both visually depicted lights (516, 518) being on, or with neither of the visually depicted lights (516, 518) being on. In other examples, the first and second visually depicted lights (516, 518) are different colors. Further, the visually depicted lights alternatively blink to convey information about the extraction devices and sensors.

In some examples, the detailed view (502) schematically represents the status information of a group of sensors, such as all of the sensors in a dock, less than all of the sensors in a dock, or more than all of the sensors in a dock. In other examples, the detailed view (512) displays just status information for a single sensor, such as displaying trends of status information for that sensor over time.

A mechanism may be used to cause the detailed view (502) to appear in the monitor's screen. For example, hovering an icon, like an icon controlled with a computer's mouse or touch pad, over a dock or single display unit may cause the detailed view (502) to appear. In other examples, a user has an ability to cause the detailed view (502) to appear by clicking on the dock or display unit. In yet other examples, the user has an ability to cause the detailed view (502) to appear by typing in manual inputs into a key board, giving speech commands through a voice recognition mechanism, other mechanisms, or combinations thereof. The monitor may have a touch screen, and a user has an ability to cause the detailed view (502) to appear by touching the portion of the screen for which the user desires a detailed view (502) to appear.

The user may have an option to select individual display units to appear in the detailed view (502). For example, a user may desire to see all of the display units that indicate that there is an issue with the corresponding sensors. In such an example, the user may select each of those display units through touch inputs, speech inputs, other inputs, or combinations thereof.

In some examples, the detailed view (502) communicates to the user different information than what is otherwise communicated to the user through the monitor's screen. The detailed view (502) may communicate to the user the same information, but displayed in a different format. Further, the detailed view (502) may display some information that is the same and other information that is different. The user may have an option to customize the detailed view (502) to better match the type of status information in which the user is interested or to present the status information in a way that is desired by the user. For example, the user may have an option to have the status information displayed in bar graphs, line graphs, pie charts, numerals, colors, written words, different languages, other formats, or combinations thereof.

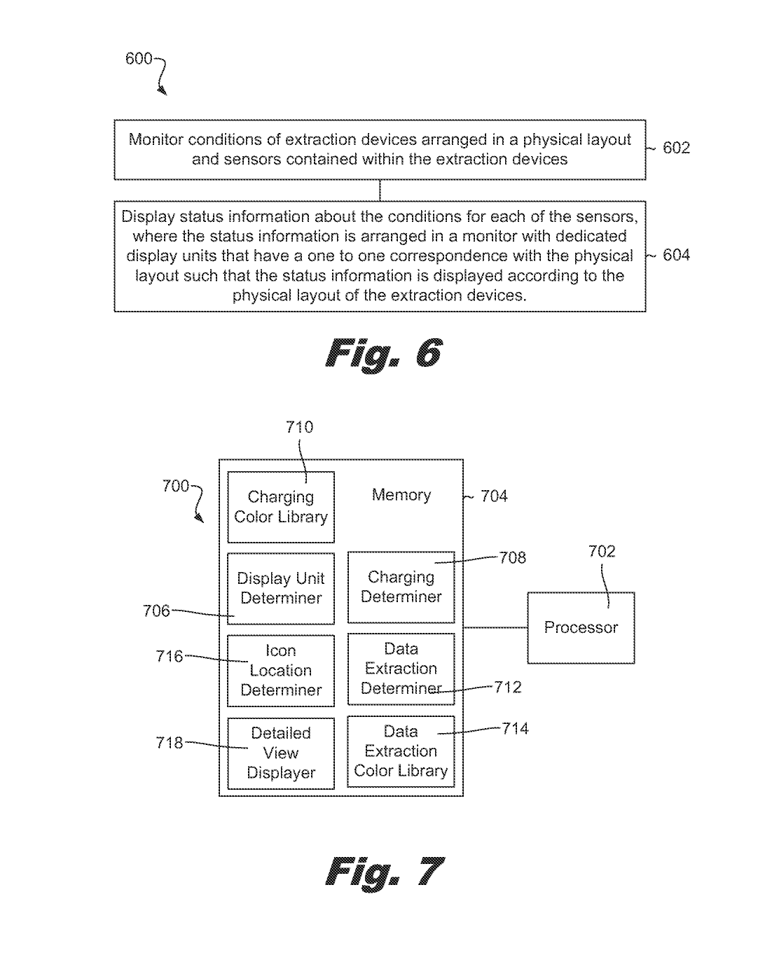

FIG. 6 is a diagram of an example of a method (600) for displaying status information from sensors according to principles described herein. In this example, the method (600) includes monitoring conditions of extraction devices arranged in a physical layout and sensors contained therein, and displaying status information about the conditions for each of the sensors, where the status information is arranged in a monitor with dedicated display units that have a one to one correspondence with the physical layout such that the status information is displayed according to the physical layout of the extraction devices.

The sensors may be incorporated in extraction devices. In some examples, the extraction devices are dock pockets. The dock pockets may be capable of receiving an end of an electrically conductive medium that allows a sensor to send recorded data and/or charge the sensor's battery. In some examples, the electrically conductive medium allows for data transfer while simultaneously passing electrical power to the sensor to charge the sensor's battery.

The monitor is set up to display the status information of at least a hundred sensors. A single monitor may be capable of displaying display units that have a one to one correspondence to over a hundred sensors. In some examples, a single monitor is capable of displaying the status information for over a thousand corresponding sensors.

The method may include updating the status information in real time in each of the dedicated display units. The status information is updated on a periodic basis, such as every second, every three seconds, every five seconds, every minute, at a predetermined number of seconds, at a predetermined number of minutes, another time period, or combinations thereof. The status information may be updated after a predetermined change threshold is met. For example, the method may include just updating the status information after a predetermined number of bites or bytes have been downloaded.

In some examples, the method includes providing additional status information in the monitor from selected data extraction devices in response to a predetermined mechanism. The mechanism may include a touch input, a computer input, a mouse input, a speech recognition input, sound input, another input, or a combination thereof.

FIG. 7 is a diagram of an example of a displaying system (700) according to principles described herein. In this example, the displaying system (700) has a processor (702) in communication with memory (704). The memory represents generally any memory capable of storing data such as program instructions or data structures used by the display system. The displaying system may be in communication with the extraction devices, the sensors, other processors, servers, the monitor, other components of the system, or combinations thereof.

The memory (704) is a computer readable storage medium that contains computer readable program code to cause tasks to be executed by the processor (702). The computer readable storage medium may be a tangible and/or non-transitory storage medium. A non-exhaustive list of computer readable storage medium types may include non-volatile memory, volatile memory, random access memory, memristor based memory, write only memory, flash memory, electrically erasable program read only memory, or types of memory, or combinations thereof.

The display unit determiner (706) represents program instructions in the memory (704). The displaying system (700) determines that a sensor is in communication with an extraction device. In response to such a determination, the display unit determiner (706) causes the processor (702) to determine which display unit in the monitor corresponds with a detected extraction device and to display that extraction device's status information.

In some examples, the processor (702) sends a request to receive status information. In other examples, the components of the system automatically send the status information to the processor (702). Alternatively, the status information is sent to the processor (702) on a periodic basis. In such examples, the periodic basis may have a short enough duration that the processor (702) is continuously receiving status information. The processor (702) may receive the status information in real time, or the status information is sent to the processor (702) by the components of the system when a pre-determined threshold is met.

The displaying system (700) may be in communication with just a selected number of sensors and corresponding display units, such as just those within a dock or trailer row. In such an example, the system may use multiple displaying systems. In other examples, the displaying system (700) has the processing ability to process the status information for all of the sensors that have data being extracted.

The charging determiner (708) represents program instructions in the memory (704). In response to receipt of status information, the processor (702) routes the status information to the appropriate determiner within the processor (702). For example, in response to the display system (700) receiving charging information, the processor (702) sends the charging information to the charging determiner (708) to cause the processor (702) to determine the level at which the extraction device and/or its associated sensor is charged. In response to making this determination, the controller (702) may consult with a charging color library (710), which is a data structure stored in the memory (704) to assign the appropriate color to make a color cell of the corresponding display unit. In other examples, the library (710) is located off of the displaying system (700), but the processor (702) may still consult the library remotely.

The data extraction determiner (712) represents program instructions in the memory (704). The processor (702) receives extraction status data about an extraction device. The processor (702) may send the extraction data to a data extraction determiner (712) where the data extraction determiner (712) causes the processor to determine the percentage of data extracted from the sensor. In response to determining the percentage of status information that has been extracted, the processor (702) may consult with a data extraction color library (714), which is a data structure stored in the memory (704). In alternative examples, the libraries (710, 714) may be located remotely and connected to the displaying system (700). In some examples, the extraction color is displayed in the border of the corresponding display unit.

While the example of FIG. 7 has been described with charging status information being displayed with a color in a color cell and with the extraction status information being displayed with another color in the display unit's border, the displaying system (700) may be programmed to cause the status information to be displayed in another ways. For examples, the charging color library (710) and the data extraction library (714) may contain colors, symbols, hatch patterns, other display mechanisms, or combinations thereof to visually communicate to the user the status information through the display unit.

The icon location determiner (716) represents program instructions in the memory (704). In examples with detailed view mechanisms, the icon location determiner (716) causes the processor to locate the position of the icon in the monitor. The icon location determiner (716) may request the icon's location. In other examples, the icon's location is sent to the display system (700) without request. The icon's location may be received by the display system (700) in real time.

The detailed view displayer (718) represents program instructions in the memory (704). In response to determining the location of the icon, the icon location determiner (716) causes the processor (702) to determine whether the user is intending to cause the detailed view to be displayed. If the icon location determiner (716) determines that the user intends to cause the detailed view to be displayed, then a detailed view displayer (718) causes the processor to display the detailed view in the monitor.

Further, the memory (704) may be part of an installation package. In response to installing the installation package, the programmed instructions of the memory (704) may be downloaded from the installation package's source, such as an insertable medium, a server, a remote network location, another location, or combinations thereof. Insertable memory media that are compatible with the principles described herein may include DVDs, CDs, flash memory, insertable disks, magnetic disks, other forms of insertable memory, or combinations thereof.

In some examples, the processor (702) and the memory (704) are located within the same physical component, such as a server, or a network component. The memory may be part of the physical component's main memory, caches, registers, non-volatile memory, or elsewhere in the physical component's memory hierarchy. Alternatively, the memory (704) is in communication with the processor (702) over a network. Further, the data structures, such as the libraries, may be accessed from a remote location over a network connection while the programmed instructions are located locally.

The system (700) of FIG. 7 may be part of a general purpose computer. However, in alternative examples, the system (700) may be part of an application specific integrated circuit.

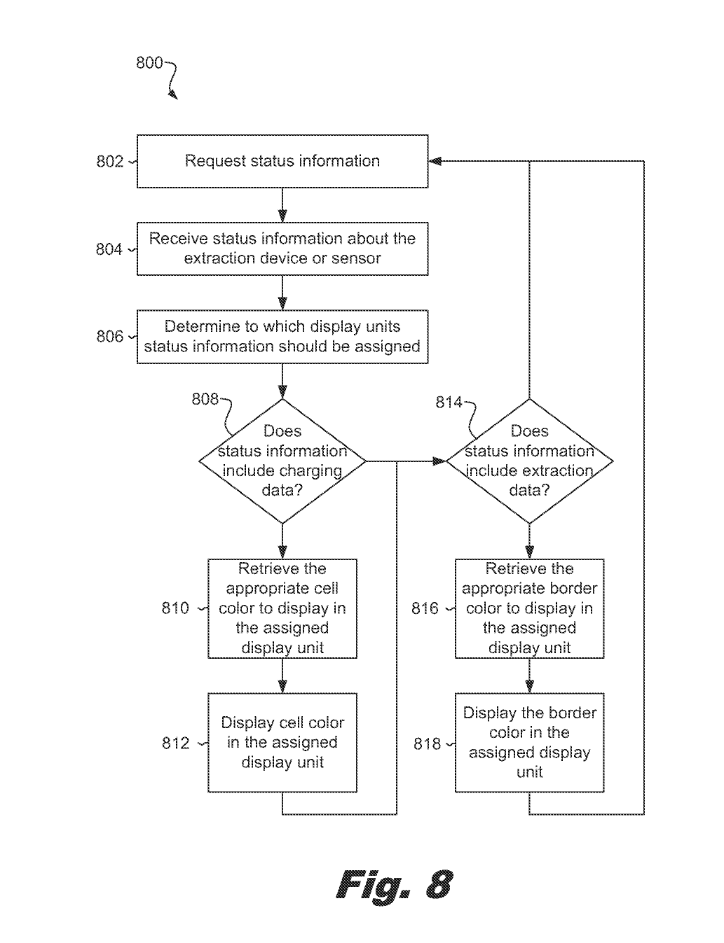

FIG. 8 is a diagram of an example of a flowchart (800) of a process for displaying status information according to principles described herein. In this example, a processor requests (802) status information about at least one sensor. The processor receives (804) the status information about the extraction device or sensor contained within the extraction device and determines (806) to which display unit the status information should be assigned. A monitor for displaying the status information has dedicated display units that display status information for just one of the sensors. The display units are arranged in the monitor in a patter that follows the physical layout of the sensors to communicate to the user a global understanding of the extraction processes or current sensor measurements by just looking at the monitor. Thousands of sensors may be monitored which would otherwise be difficult for a user to track due to the large volume of information. However, with the principles described herein, the user can quickly determine to which sensors to devote his or her attention.

In response to determining (806) to which display unit to assign the status information, the process determines (808) whether the status information includes charging data. If the status information does include charging data, then the process retrieves (810) the appropriate cell color to display in the assigned display unit and display (812) the appropriate cell color in the assigned display unit.

Next, the process determines (814) whether the status information includes extraction data or if the status information does not include charging data. If the process does include extraction data, then the process includes retrieving (816) the appropriate border color to display in the appropriate display unit and displaying (818) the border color in the assigned display unit.

Next, the process requests (802) updated status information or if the status information does not include extraction data, then the process proceeds to requesting (802) updated status information. In other examples, the process includes determining whether other types of status information exist and retrieving the appropriate color, symbol, other visual indicia, or combinations thereof to display in the appropriate display unit of the monitor.

While the examples above have been described in relation to extracting data from geophysical surveys, the sensors and/or nodes from which the data is extracted may be part of any type of network. Such networks may be corporate networks, health monitoring networks, environmental networks, surveillance networks, security networks, research networks, equipment maintenance networks, extraterrestrial monitoring networks, building maintenance networks, other networks, or combinations thereof.

The preceding description has been presented only to illustrate and describe examples of the principles described. This description is not intended to be exhaustive or to limit these principles to any precise form disclosed. Many modifications and variations are possible in light of the above teaching.

What is claimed is:

1. A method for displaying status information of sensors and extraction devices, comprising:
monitoring conditions of extraction devices arranged in a physical layout and sensors contained within said extraction devices; and
displaying status information about said conditions for each of said sensors, where said status information is arranged in a monitor with dedicated display units that have a one to one correspondence with said physical layout such that said status information is displayed according to said physical layout of said extraction devices.

2. The method of claim 1, wherein said sensors are network sensors, nodes, or combinations thereof.

3. The method of claim 1, wherein displaying status information about said conditions includes displaying status information from at least a hundred sensors in a single monitor.

4. The method of claim 1, wherein displaying status information about said conditions includes displaying at least two types of said status information with variable colors in said dedicated display units.

5. The method of claim 1, further comprising updating said status information in real time in said dedicated display units.

6. The method of claim 1, further comprising providing additional status information in said monitor from selected extraction devices in response to a predetermined mechanism.

7. A system for displaying status information of sensors and extraction devices, comprising:
multiple extraction devices with sensors contained within said extraction devices arranged in a physical layout; and
a processor programmed to
cause display units to appear in a monitor; and
display status information about conditions of said extraction devices in a one to one correspondence between said extraction devices and said display units such that said status information is displayed according to said physical layout.

8. The system of claim 7, wherein each of said display units is capable of displaying multiple types of said status information.

9. The system of claim 7, wherein said display units comprise a variable color that represents said status information about said extraction devices.

10. The system of claim 7, wherein said display units comprise a variable border that represents said status information from said extraction devices.

11. The system of claim 7, wherein said physical layout comprises multiple dock pockets arranged in docks situated in dock trailers.

12. The system of claim 7, wherein said monitor comprises a mechanism to provide a detailed view of said status information of selected extraction devices.

13. The system of claim 12, wherein said mechanism is triggered in response to a hovering icon over one of said display units that correspond to said selected extraction devices.

14. A monitor for displaying status information of sensors and extraction devices, comprising:
a processor programmed to
cause display units to appear in an arrangement after a physical layout of extraction devices; and
display status information about multiple conditions of said extraction devices with sensors contained within said extraction devices in a one to one correspondence between said extraction devices and said display units such that said status information is displayed according to said physical layout of said extraction devices.

15. The monitor of claim 14, wherein said processor is programmed to display said status information about a first of said multiple conditions with a variable color cell of said display units and to display said status information about a second of said multiple conditions with a variable color border of said display units.
